(19) United States
(12) Patent Application Publication
(10) Pub. No.: US 2020/0090145 A1
(43) Pub. Date: Mar. 19, 2020

(54) SYSTEM AND METHOD TO CONFIGURE A DATA TRANSFER USING A CONTINUOUS GESTURE

(71) Applicant: THE TORONTO-DOMINION BANK, Toronto (CA)

(72) Inventors: STEVEN GERVAIS, NEWMARKET (CA); PETER HORVATH, TORONTO (CA)

(21) Appl. No.: 16/130,158

(22) Filed: Sep. 13, 2018

(51) Int. Cl. G06Q 20/10; G06F 3/01; G06Q 20/32; G06Q 40/02

(52) U.S. Cl. CPC G06Q 20/102; G06Q 40/02; G06Q 20/322; G06F 3/017

(57) ABSTRACT

A computing device configured to communicate with a display provides a graphical user interface (GUI) and receives gestural input interacting with the GUI. The computing device produces a UI with which to define a data transfer, receiving gestural input linking a source control from a plurality of such controls and a destination control from a plurality of such controls. The data transfer is communicated to a processing device for processing. The UI may receive a gestural input selecting two or more sources to link with a destination such as to define a split data transfer or to receive a gestural input linking two or more destinations with a source to define multiple data transfers with one input. A secondary UI may present controls to further specify the data transfer. A plurality of data transfers may be defined and presented for confirmation as a batch or individually cancelled before communicating.

The present disclosure relates to gesture-based computer interfaces and more particularly to a system and method to configure a data transfer using a continuous gesture.

### BACKGROUND

Graphical user interfaces (GUIs) for functions and applications for computer and other devices enable users to receive information and provide input, for example, to invoke an action such as a function, feature or service. Graphical user interfaces can play a significant role in the user experience and satisfaction in dealing with the associated device. Complicated user interfaces may result in erroneous user input. Such input may waste computer or other resources through unnecessary action while performing or partially performing undesired functions, features or services or in correcting the input. As well, some GUIs are more resource intensive than others, using computer resources unnecessarily.

Defining data transfer content can be time consuming and error prone. It is vital to define certain data transfers with correct content. It is helpful to do so simply and efficiently to avoid wasting resources.

### SUMMARY

A computing device configured to communicate with a display provides a graphical user interface (GUI) and receives gestural input interacting with the GUI. The computing device produces a UI with which to define a data transfer, receiving gestural input linking a source control from a plurality of such controls and a destination control from a plurality of such controls. The data transfer is communicated to a processing device for processing. The UI may receive a gestural input selecting two or more sources to link with a destination such as to define a split data transfer or to receive a gestural input linking two or more destinations with a source to define multiple data transfers with one input. A secondary UI may present controls to further specify the data transfer. A plurality of data transfers may be defined and presented for confirmation as a batch or individually cancelled before communicating.

There is provided a computing device comprising a processor, a storage device and a communication device where each of the storage device and the communication device is coupled to the processor, the storage device storing instructions, which when executed by the processor, configure the computing device to: provide a user interface (UI) to receive input and display output via a gesture-based input and output device coupled to the processor, the UI configured to: present a first plurality of controls and a second plurality of controls, wherein each of the first plurality of controls is associated with a respective source and wherein each of the second plurality of controls is associated with a respective destination; and receive a gesture input linking a one of the first plurality of controls and one of the second plurality of controls. The computing device is further configured to define a data transfer from the respective source associated with the one of the first plurality of controls to the respective destination associated with the one of the second plurality of controls; and communicate the data transfer to a data transfer processing device, via the communication device, to process the data transfer.

The UI may be configured to receive a gesture input linking one of the first plurality of controls and one or more of the second plurality of controls.

In response to a gesture input linking the one of the first plurality of controls to at least two of the second plurality of controls, the instructions may configure the processor to define respective data transfers comprising one transfer to each respective destination associated with the at least two of the second plurality of controls.

The UI may be configured to receive a gesture input linking one or more of the first plurality of controls and the one of the second plurality of controls. In response to a gesture input linking at least two of the first plurality of controls, the instructions may configure the processor to define respective data transfers as a split transfer from each respective source associated with the at least two of the first plurality of controls to the respective destination associated with the one of the plurality of second controls.

The UI may be configured to: receive a first component of the gesture input as a selection of the one of the first plurality of controls or a selection of the one of the second plurality of controls; and receive a second component of the gesture input as a selection of the other of the one of the first plurality of controls or the one of the second plurality of controls.

The UI may be configured to, in response to the gesture input and before defining the data transfer, provide a secondary UI to further configure the data transfer. The second plurality of controls may be further associated with transfer parameters defining a request and wherein the secondary UI is configured to present at least one of: an interface to instruct the computing device to define the data transfer to fully satisfy the request in accordance with the transfer parameters; an interface to instruct the computing device to define the data transfer to minimally satisfy the request in accordance with the transfer parameters; and an interface to instruct the computing device to define the data transfer with custom information. The request may be a payment request, the transfer parameters may comprise a full payment amount and the secondary UI may be configured to receive input to specify an amount to be transferred.

The gesture input may be a swipe input comprising a selection and movement linking the one of the first plurality of controls and the one of the second plurality of controls.

The UI may be configured to present a confirmation control to receive a confirmation input to communicate the data transfer.

The instructions may configure the processor to define a plurality of data transfers and the UI is further configured to present the plurality of data transfers before communicating and present a batch confirmation control to receive a single confirmation input to confirm each individual data transfer of the plurality of data transfers. Each individual data transfer may be presented with a respective cancel control to receive a cancel input to cancel any individual data transfer.

The computing device may be configured to communicate via the communication device with an information storage device to: receive respective source information for each of the first plurality of controls, each of the first plurality of controls displayed in association with the respective source information; and receive respective destination information for each of the second plurality of controls, each of the second plurality of controls displayed in association with the respective destination information. The instructions may configure the processor to use the respective source information and respective destination information when defining the data transfer.

Each respective source may be a respective financial account, each respective destination may be a respective unpaid bill and the data transfer may be a bill payment.

There is provided a computer implemented method comprising: providing a user interface (UI) to receive input and display output via a gesture-based input and output device coupled to a processor where the UI is configured to: present a first plurality of controls and a second plurality of controls, wherein each of the first plurality of controls is associated with a respective source and wherein each of the second plurality of controls is associated with a respective destination; and receive a gesture input linking a one of the first plurality of controls and one of the second plurality of controls. The method further comprises: defining a data transfer from the respective source associated with the one of the first plurality of controls to the respective destination associated with the one of the second plurality of controls; and communicating the data transfer to a data transfer processing device, via a communication device, to process the data transfer. Each respective source may be a respective financial account, each respective destination may be a respective unpaid bill and the data transfer may be a bill payment.

The UI may be configured to receive a single gestural input to link: i) two of the first plurality of controls with one of the second plurality of controls; or ii) one of the first plurality of controls with two of the second plurality of controls; and wherein defining a data transfer defines two data transfers in response to respective pairs of linked controls. There is provided a computer program product comprising a non-transient storage device storing instructions that when executed by at least one processor of a computing device, configure the computing device to perform in accordance with the methods herein.

These and other aspects will be apparent to those of ordinary skill in the art.

### BRIEF DESCRIPTION OF THE DRAWINGS

FIG. 1 is a diagram illustrating an example computing device communicating in a communication network and configured to output for display a graphical user interface via a gesture-based input/output (I/O) device, in accordance with one or more aspects of the present disclosure.

FIG. 2 is a diagram illustrating an example computing device, in accordance with one or more aspects of the present disclosure.

FIGS. 3A-3H, 4A-4C, 5A-5E, 6A-6C and 7 are diagrams illustrating example graphical user interfaces or portions thereof, in accordance with one or more aspects of the present disclosure.

FIG. 8 is a flowchart illustrating example operations of a computing device, in accordance with one or more examples of the present disclosure.

### DETAILED DESCRIPTION

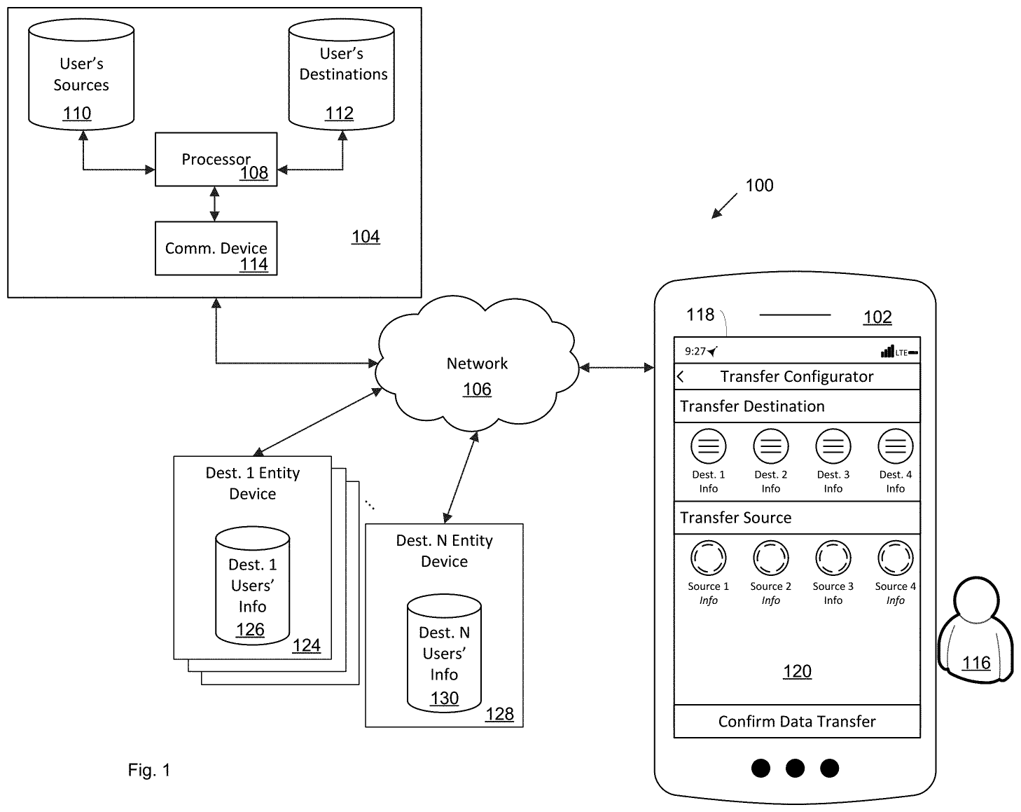

FIG. 1 is a diagram illustrating an example computer network 100 in which a computing device 102 is configured to communicate with one or more other computing devices, including data transfer processing device 104, using a communication network 106. Data transfer processing device 104 comprises a processor 108 and data stores 110 and 112 (comprising storages devices) coupled thereto as well as a communication device 114. It is understood that this is a simplified illustration. Data transfer processing device 104 processes data transfers between a source such as a user account and a destination such as a user bill to be paid, information for each being stored in data stores 110 and 112 respectively. Data transfer processing device is configured to provide information from its storage devices to computing device 102, which is configured to define data transfers using gestural input such as from a user 116. Computing device 102 is configured to display, via a gesture-based I/O device 118, a graphical user interface (GUI) 120, in accordance with one or more aspects of the present disclosure. Computing device 102, using GUI 120, may receive input to perform an action. In a present non-limiting example, the input defines a bill payment data transfer. Data transfer processing device 104 may receive destination information from a plurality of destination entity devices (e.g. N devices, Dest. 1 . . . Dest. N) (e.g. 124 and 128) each having respective data stores 126 and 130 storing destination user information for its clients/users. Data transfer processing device 104 may process payments through a payment network (e.g. a group of networked computing devices, not shown) for user 116 to respective destination entities operating (or on whose behalf) the destination entity devices 124 and 128 are operated. Though only one user device (computing device 102) is illustrated, data transfer processing device 104 may process respective data transfers for respective users of a plurality of computing devices and each computing device may be configured similarly to computing device 102.

In the example of FIG. 1, computing device 102 is a mobile phone. Other examples of computing device 102 may be a tablet computer, a personal digital assistant (PDA), a laptop computer, a tabletop computer, a portable gaming device, a portable media player, an e-book reader, a watch, or another type of computing device. In the example of FIG. 1, data transfer processing device 104 and destination entity devices 124 and 128 are servers. Each of these is an example of a computing device having at least one processing device (e.g. a processor, etc.) and memory (e.g. a storage device, etc.) storing instructions which when executed by the processing device configure the computing device to perform operations.

Computing device 102 is coupled for communication to communication network 106 which may comprise a wide area network (WAN) such as the Internet. Communication network 106 is coupled for communication with a plurality of computing devices. It is understood that communication network 106 is simplified for illustrative purposes. Communication network 106 may comprise additional networks coupled to the WAN such as a wireless network and/or local area network (LAN) between the WAN and computing device 102 (not shown), etc.

Although the present disclosure illustrates and discusses a gesture-based I/O device 118 primarily in the form of a screen device with 10 capabilities (e.g. touchscreen), other examples of gesture-based I/O devices may be utilized which may detect movement and which may not comprise a screen per se. Computing device 102 may receive gesture-based input from a track pad/touch pad, one or more cameras, or another presence or gesture sensitive input device, where presence means presence aspects of a user including for example motion of all or part of the user.

Computing device 102 may generate output for display on a screen of gesture-based I/O device 118 or in some examples, for display by a projector, monitor or other display device. It will be understood that gesture-based I/O device 118 may be configured using a variety of technologies (e.g. in relation to input capabilities: resistive touchscreen, a surface acoustic wave touchscreen, a capacitive touchscreen, a projective capacitance touchscreen, a pressure-sensitive screen, an acoustic pulse recognition touchscreen, or another presence-sensitive screen technology; and in relation to output capabilities: a liquid crystal display (LCD), light emitting diode (LED) display, organic light-emitting diode (OLED) display, dot matrix display, e-ink, or similar monochrome or color display).

In the examples described herein, gesture-based I/O device 118 includes a touchscreen device capable of receiving as input tactile interaction or gestures from a user interacting with the touchscreen. Such gestures may include tap gestures, dragging or swiping gestures, flicking gestures, pausing gestures (e.g. where a user touches a same location of the screen for at least a threshold period of time) where the user touches or points to one or more locations of gesture-based I/O device 118. Gesture-based I/O device 118 and may also include non-tap gestures. Gesture-based I/O device 118 may output or display information, such as GUI 120, to a user. The gesture-based I/O device 118 may present various applications, functions and capabilities of the computing device 102 including, for example, messaging applications, telephone communications, contact and calendar applications, Web browsing applications, game applications, e-book applications and financial, payment and other applications or functions among others.

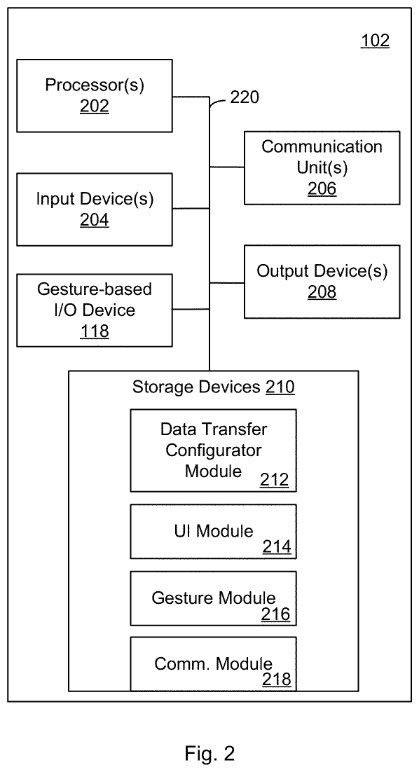

FIG. 2 is a diagram illustrating in block form an example computing device (e.g. computing device 102), in accordance with one or more aspects of the present disclosure, for example, to provide a system to perform a configuration of a data transfer using a continuous gesture. Computing device 102 comprises one or more processors 202, one or more input devices 204, gesture-based I/O device 118, one or more communication units 206 and one or more output devices 208. Computing device 102 also includes one or more storage devices 210 storing one or more modules such as data transfer configurator module 212, UI module 214, gesture module 216 and communication module 218. Communication channels 220 may couple each of the components 118, 202, 204, 206, 208, 210, 212, 214, 216 and 218 for inter-component communications, whether communicatively, physically and/or operatively. In some examples, communication channels 220 may include a system bus, a network connection, an inter-process communication data structure, or any other method for communicating data.

One or more processors 202 may implement functionality and/or execute instructions within computing device 102. For example, processors 202 may be configured to receive instructions and/or data from storage devices 210 to execute the functionality of the modules shown in FIG. 2, among others (e.g. operating system, applications, etc.) Computing device 102 may store data/information to storage devices 210. Some of the functionality is described further herein below.

One or more communication units 206 may communicate with external devices (e.g. data transfer processing device 104) via one or more networks (e.g. communication network 106) by transmitting and/or receiving network signals on the one or more networks. The communication units may include various antennae and/or network interface cards, etc. for wireless and/or wired communications.

Input and output devices may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 220).

The one or more storage devices 210 may store instructions and/or data for processing during operation of computing device 102. The one or more storage devices may take different forms and/or configurations, for example, as short-term memory or long-term memory. Storage devices 210 may be configured for short-term storage of information as volatile memory, which does not retain stored contents when power is removed. Volatile memory examples include random access memory (RAM), dynamic random access memory (DRAM), static random access memory (SRAM), etc. Storage devices 210, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

Data transfer configurator module 212 may comprise an application (whether native or browser-based) and may be configured to obtain input to perform an action. An action herein is construed broadly as an operation of computing device 102 or an operation of one or more other computing devices (e.g. one or more servers providing data transfer processing device 104) to which computing device 102 is coupled or other devices to which computing device 102 is coupled which other device may not be a computing device per se (e.g. equipment). Data transfer configurator module 212 enables a user to define a data transfer between a source and a destination using gestural input. In one example, the data transfer is a bill payment. Other allocations may be defined by a data transfer. While in a bill payment context, a transfer is made from a user account to a third party account associated with a user's bill, an allocation may be made between user accounts or between accounts of different users. Data transfer configurator module 212 may cooperate with UI module 214 and gesture module 216 to present a user interface and receive gesture input via gesture-based I/O device 118. Certain information to present in the user interface may be obtained from data transfer processing device 104 (e.g. its data stores 110 and 112) for example, looking up data stored on behalf of the user.

Gesture module 216 may receive input from gesture-based I/O device 118 entered via the touchscreen, processing same for communication with data transfer configurator module 212 and/or UI module 214 and/or others not shown. In some configurations, the gesture module 216 may be a component of an operating system. In response to input detected by gesture-based I/O device 118, gesture module 216 may receive information for processing. The information may be aggregated or grouped to generate one or more touch or gesture events. The events may include data representing a location on gesture-based I/O device 118 where the input is received, a time when the input or part thereof is received at the location, and/or a direction component (e.g. push down, pull up, lateral motion). The touch events may be communicated to the data transfer configurator module 212 and/or UI module 214 for further processing.

Data transfer configurator module 212 and/or UI module 214 may use the data associated with the one or more gesture events to determine a response. In one example, data transfer configurator module 212 may, based on the location components of these touch events, link one respective control associated with a destination with one respective control associated with a source and may invoke UI module 214 to modify the GUI for output via gesture-based I/O device 118 to reflect the linking. Data transfer configurator module 212 may define a data transfer accordingly and generate a signal comprising the data transfer to instruct the performance of the data transfer and communicate (e.g. via communication module 218) the signal such as to data transfer processing device 104.

Respective controls associated with the regions (e.g. software/instructions in UI module 214 and/or data transfer configuration module 212) receive gesture input (e.g. via gesture module 216) such as a tap or other interaction to invoke the control. Gesture module 216 and/or UI module 214 may determine the location of the gesture to determine which control is to be invoked. In some examples the effective location to invoke a respective control may be a sub-region, namely a portion of a region where GUI elements associated with the control are displayed. A region may have graphic elements which if interacted with do not actually invoke the control. Only if the sub region is interacted with the control is invoked.

It will be understood that a swipe input requires a continuous interaction with the interface elements of the UI and the device can provide the user with interaction references to allow for easier targeting for the user. This is not the case for tap-based interfaces. These multiple taps require the user to completely disconnect their interaction with the relevant module or component processing the tap interaction to retarget the next step (e.g. tap) in the interface. Such can lead to errors in inputting and thus errors in or otherwise wasted operations by the device or system with which the device is communicating as the device and/or system processes that erroneous input.

It is understood that operations may not fall exactly within the modules 212-218 of FIG. 2 such that one module may assist with the functionality of another.

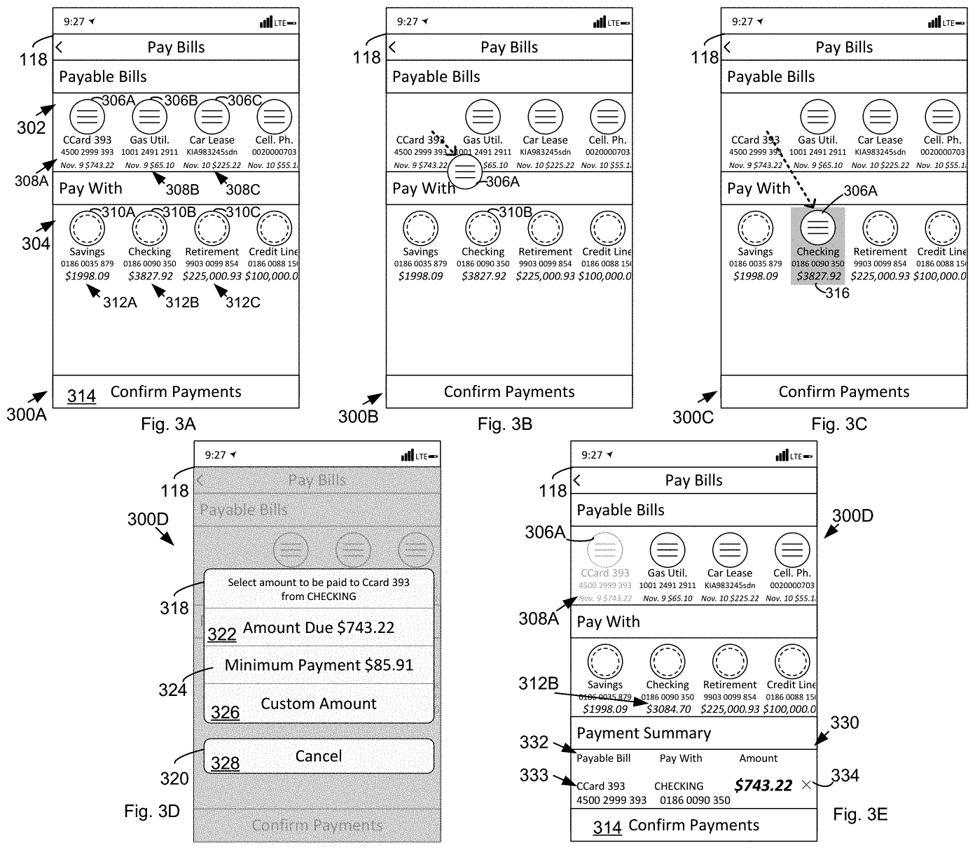

FIGS. 3A-3H, 4A-4C, 5A-5D, 6A-6C and 7 are diagrams illustrating example graphical user interfaces, in accordance with one or more aspects of the present disclosure. These GUIs may be generated by computing device 102 for output by gesture-based I/O device 118. FIGS. 3A-3H, 4A-4C, 5A-5D, 6A-6C and 7 illustrate a GUI for configuring a data transfer comprising a transfer according to respective examples.

FIG. 3A-3E shows views 300A-300E of a GUI comprising a plurality of GUI elements in respective regions 302-304, etc. of a display such as a screen of gesture-based I/O device 118. A region here is a portion of the screen having a respective location. The location is typically a two dimensional shape. A region may comprise a control for receiving input and invoking an action or may comprise information displayed to the user. In some examples, a control and information provided. Region 302 comprises a plurality of destination controls including destination control 306A, destination control 306B and destination control 306C with associated destination information including destination information 308A, destination information 308B and destination information 308C. Destination controls are represented as icons. Region 304 comprises a plurality of source controls including source control 310A, source control 310B and source control 310C with associated source information including source information 312A, source information 312B and source information 312C. Source controls are represented as icons. Though not shown, additional controls and associated information may be presented in these respective regions such as by scrolling left or right, up or down, etc.

Destination controls and source controls are associated with respective destinations and sources. A respective destination is a receiver for a data transfer and a respective source is an originator for the data transfer. In some of the examples herein, a respective destination is an unpaid bill associated with a destination entity who issued the bill and a respective source is a user's financial account at a respective source entity such as a financial institution.

It is noted that destination controls and source controls may be ordered for presentation. For example, when destination controls are associated with unpaid bills, the order may be according to a due date which may be presented with the destination information. Destination information may include the name of a destination (e.g. credit card, gas utility, car loan, etc.) as well as amount owing, due date and account number. Source controls may be ordered according to a user preference or a user use count where, for example, when a source is a financial account, based on the frequency of use of the account by the user. A further region displays a confirmation control 314 to confirm the configuration of the data transfers prior to communicating same as further described below.

In accordance with an example, a user may configure a data transfer using a gesture to link a source and a destination such as by linking a source icon and a destination icon. In the present example, the destination icon for destination control 306A is linked to the source icon for source control 310B such as by a swipe input gesture. Such a gesture initiates a definition of a data transfer to transfer payment from a checking account source associated with source control 310B to the credit card bill associated with destination control 306A. View 300B shows the destination icon for destination control 306A partially swiped to the source icon for source control 310B and the path of the swipe is shown by the dotted arrow line. View 3C shows the completed gesture where the controls are linked. The UI is updated to reflect the link such as by highlighting around source control 310B and source information 312B. Other methods may be used. It is also shown that when the destination icon for destination control 306A is selected and moved away from its initial position by the swipe input, the icon appears to be lifted and moved. Other methods to show the selection and movement may be used.

View 300D shows a UI response to the linking of the controls. In response, a secondary UI is invoked for display by the gesture-based I/O device 118. This secondary UI provides a manner to further configure the data transfer. A bill from a destination entity is a type of request, namely a payment request to pay an amount of money. Thus in one example, the UI may configure a data transfer comprising a payment of money from the user to the destination entity. In the present example of the views 300A-300H, each of the first plurality of controls and the second plurality of controls are associated with transfer parameters such as are provided by the respective destination information and source information. The destination information provides at least some of the transfer parameters to effect the transfer for a receiving party (e.g. a destination entity). The source information may provide additional transfer parameters for the sending party (e.g. user 116 from its financial institution). With reference to view 300A, the destination information (e.g. 308A-308C) and source information (e.g. 312A-312C) each display some of the associated transfer parameters such as a destination or source identifier (e.g. CCard 383, Checking, etc.) source or destination account number, amount owing, balance of account. Fewer or other transfer parameters may be shown. The source and destination information, which may include information (parameters) that are not displayed may be obtained from the data stores (an example of an information storage device) of data transfer processing device 104. In other examples of computer network 100, the transfer parameters (source information and destination information) may be retrieved from data stores provided by a computing device (not shown) that is separate from data transfer processing device 104, for example, to balance processing and/or communication loads, security, etc. These transfer parameters may be used to define the data transfer which is to be communicated to data transfer processing device 104. Thought not shown, data transfer processing device 104 may use the transfer parameters or other data received from computing device 102 in association with a data transfer communication to obtain and/or use other parameters to effect an actual payment transfer to the appropriate destination entity. This may reduce communication of information to and from computing device 102 (and from and to data transfer processing device 104).

When paying a bill there is typically a specific amount to fully satisfy the bill (e.g. a full payment amount) and there may be a partial amount to minimally satisfy the amount due on the bill. This is particularly true for credit cards where interest is charged on unpaid balance as a type of consumer financing. The secondary UI may comprise one or more regions 318 and 320. Region 318 provides controls to define the amount to transfer. Full amount control 322 instructs an amount to fully satisfy the bill. Minimal amount control 324 instructs an amount to minimally satisfy the bill and custom amount control 326 invokes an interface to receive a custom amount (not shown). Region 320 of the secondary UI provides a cancel control 328 to stop the configuring and defining of the data transfer (not shown). Thus the secondary UI is configured to provide at least one of: an interface to instruct the computing device to define the data transfer to fully satisfy the request in accordance with the transfer parameters; an interface to instruct the computing device to define the data transfer to minimally satisfy the request in accordance with the transfer parameters; and an interface to instruct the computing device to define the data transfer with custom information.

View 300E shows the GUI now displaying a payment summary in region 330 with a title 332 and individual entries (e.g. 333) for individual data transfers such as the one just defined. An individual cancel control 334 is provided to cancel a data transfer before it is communicated to the data transfer processing device 104. Region 330 is scrollable to review all unconfirmed data transfers. Confirmation control 314 may be invoke (by receiving a confirmation input, which may be a tap in a touchscreen example) to confirm all data transfers in the summary of region 330 and communicate same though at present only one data transfer is shown. Confirmation control 314 provides a batch confirmation control in that all data transfers (i.e. a “batch”) are confirmed with a single confirmation input. The UI may be updated to reflect the amount to be removed from the source. Source information 312B is so updated in view 300E.

Views 300F-300H show a second data transfer configuration to pay a second bill using destination control 306B associated with the gas utility linking with source control 310B associated with the checking account source. In view 300G the secondary UI in region 318 does not display a minimum amount for the bill as there is no corresponding information in destination information 308B. In view 300H, two data transfers are summarized in region 330 each having a respective cancel control (e.g. 334). Cancel control 334 may receive a tap or other cancel input to remove the data transfer. Both data transfers (i.e. all data transfers in the summary) may be confirmed via confirmation control 314 by a single confirmation input.

Though FIGS. 3A-3H show configuration by a first component of the gestural input selecting the destination control (an icon) to link to the source control (an icon) by a second component of the gestural input, the UI may be configured to allow the opposite, selecting the source icon and linking to the destination icon via components of the gestural input. It is understood that the gestural input may comprise a press down or tap down on a touchscreen to select the initial icon and then, without raising from the touchscreen, swiping along the screen in a path toward and onto the second icon raising from the touchscreen all in a continuous movement of respective components. In this way the gesture-based I/O device 118 is engaged throughout the input sequence.

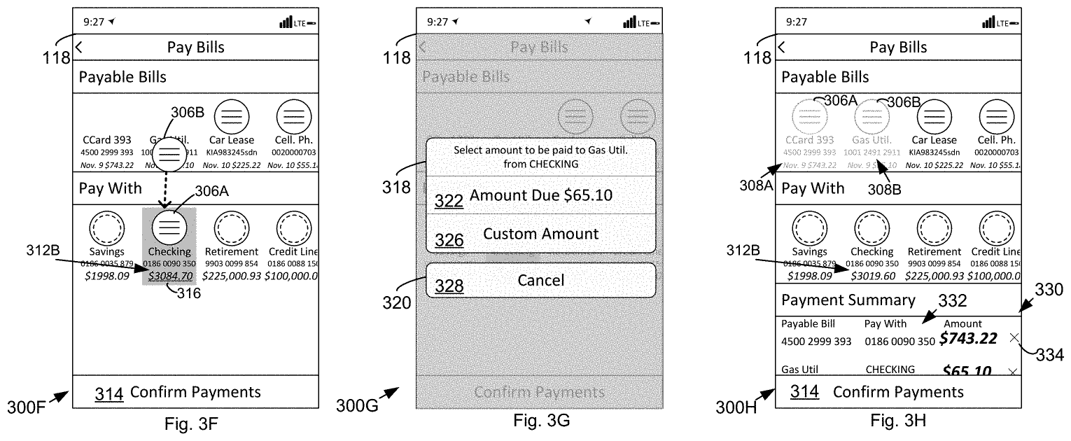

FIGS. 4A-4C show a data transfer configuration where multiple data transfers are defined using one gestural input comprising respective components. The multiple data transfer comprise one data transfer for each respective destination associated with two or more destination controls linked via the one gestural input to a source control. In FIG. 4A, view 400A shows the same initial view as FIG. 3A. Here, the UI is configured to permit selecting and swiping a single source control to multiple destination controls. In view 400B, source control 310A is selected and moved toward destination control 306A as indicated by the dotted arrow line. Destination control 306A may be selected by pausing source control 310A over destination control 306A, for example, without disengaging. In view 400C, source control 310A is moved along to destination control 306C, over destination control 306B without selecting it. Destination control 306A and destination information 308A are highlighted to show the selection as is destination control 306C and destination information 308B. A secondary UI, similar to views 300D and 300G may be invoked to further configure each data transfer, for example, in a serial fashion according to an order. The order may be based on first selected to last selected, last selected to first selected or based on date order, etc. The data transfer summary may be displayed in region 330 and confirmed via confirmation control 314 (both not shown).

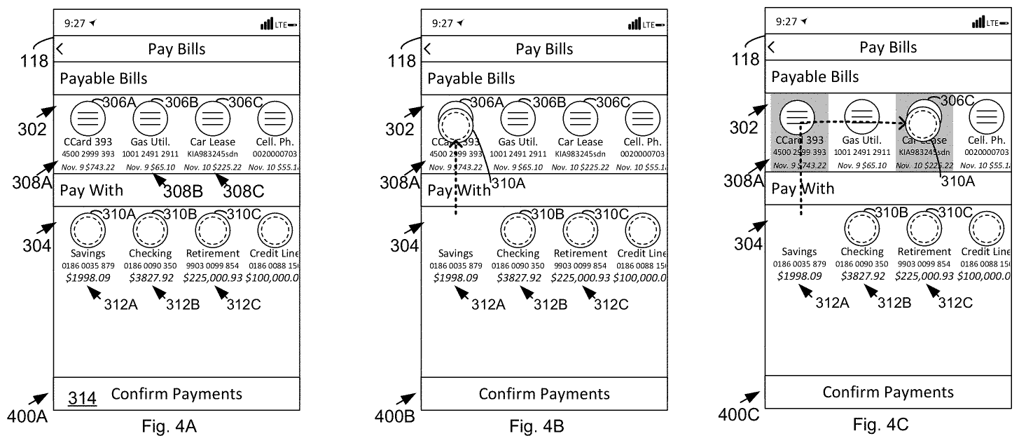

FIGS. 5A-5E show views 500A-500E for configuring a split data transfer using a single gestural input to select a destination control and move it to select two source controls. Though not illustrated, two source controls may be first selected to link to a destination control. FIG. 5A showing view 500A is similar to view 300A, and here the UI is configured for a split data transfer. View 500B shows a selection of destination control 306C and movement toward source control 310B. In this example, a ghost icon is displayed where destination control 306C originated and the destination information 308C is also ghosted (dimmed). In response to the linking of the destination control 306C and source control 310B, the region 316 thereabout is highlighted to represent the selection. View 500C shows movement of destination control 306C to link source control 310A for the split data transfer. The region thereabout 317 is also highlighted.

In response to the linking of the two source controls, the UI presents a secondary UI to further configure the transfer as shown in view 500D of FIG. 5D. Region 318 of the secondary UI may display a default split control 506 to split the payment amount between the two accounts on a 50/50 basis. Full amount control 322 showing the full amount to be paid may, in this example, be disabled, or may invoke a further UI to select one of the source accounts to pay the full amount should a user change their mind. Custom amount control 326 may invoke an interface to receive a custom amount. The custom amount may specify a different split between the two sources, a specific amount for one where the other is calculated automatically based on the amount due or custom amounts from both if paying less than the amount due (all not shown). FIG. 5E shows view 500E where the data transfer summary of region 330 shows the two data transfers, each with a respective cancel control 334. Source information 312A and source information 312B for each respective source is updated to reflect the amount to be paid.

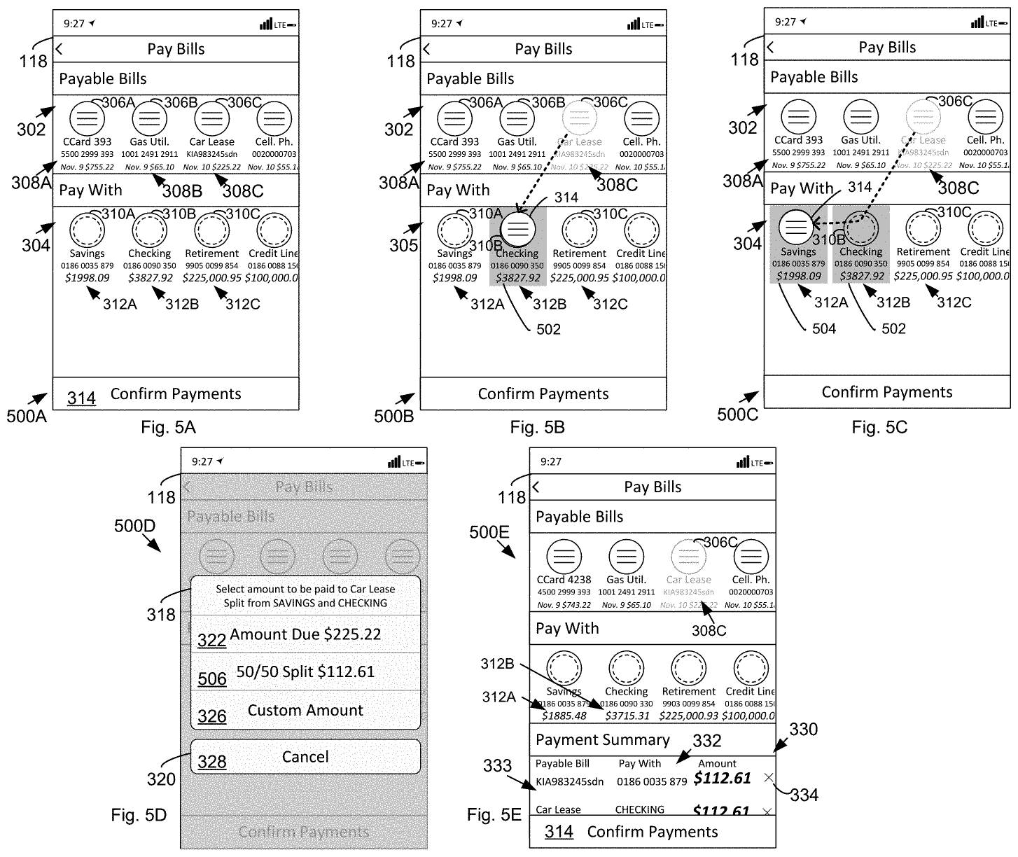

FIGS. 6A-6C show views 600A-600C show a data transfer configuration where multiple data transfers are defined using one gestural input comprising respective components. Views 600A-600C are similar to views 400A-400C but where the data transfer configuration begins by selecting the destination controls to link with a source control rather than a source control initially selected to link with two destination controls. View 600A is similar to view 300a with the UI configured to select two destination controls. View 600B shows a selection of destination control 306A and movement toward destination control 306B. The original location of destination control 306A displays a ghosted control (icon). Destination information 308A is also dimmed. View 600C shows a prior selection of destination control 306B and movement to and selection of source control 310B by positioning the destination icon on top of the source icon (i.e. destination control 306A on source control 310B). The single gesture links two destination controls to one source control defining two pairs of links. Such a configuration can generate two data transfers, on for each pair of linked controls, in this case one pair is destination control 306A and source control 310B and one pair is destination control 306B and source control 310B. The UI can present a secondary UI as previously discussed. The transactions may be displayed in the summary of region 330 and confirmed as discussed.

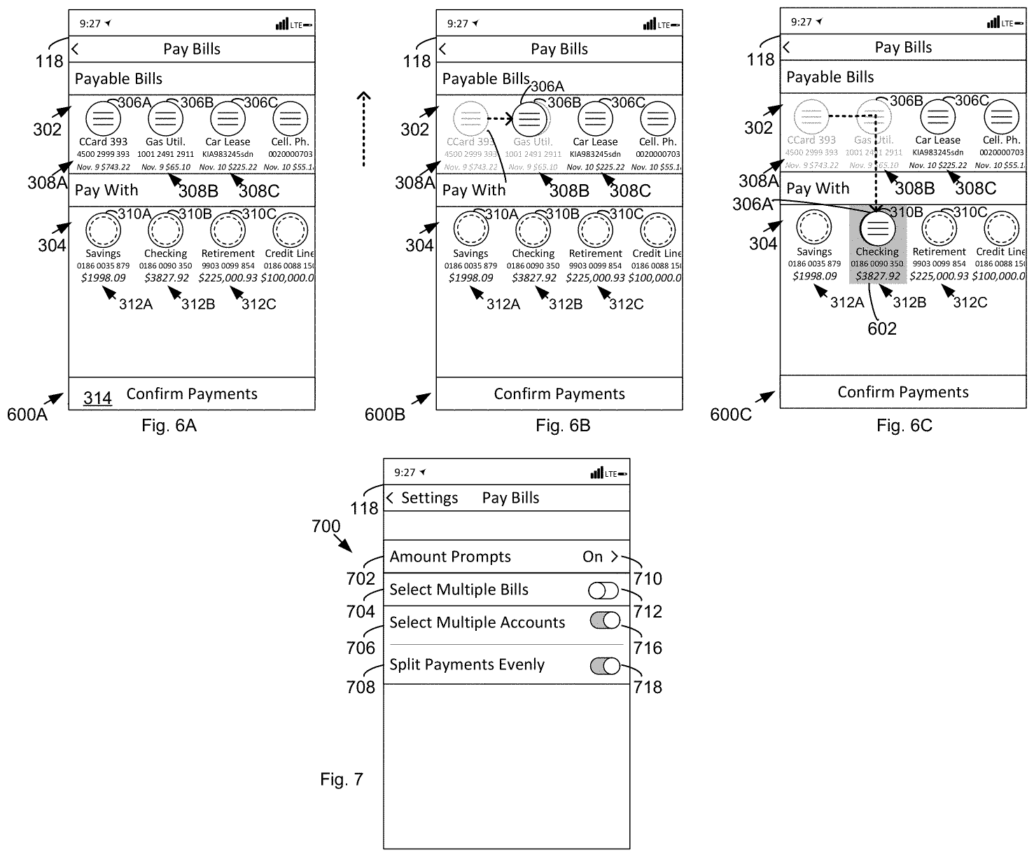

Various configurations of the UI may be optional. FIG. 7 shows view 700 of a settings UI for the data transfer configurator with regions 702-708 and respective controls 710-716 for amount (secondary UI), selecting multiple destinations, selecting multiple sources, and whether the split transfer should be 50/50. If the prompt for amounts (secondary UI) is not ON, then the data transfers are prepared automatically once the sources and destinations are linked.

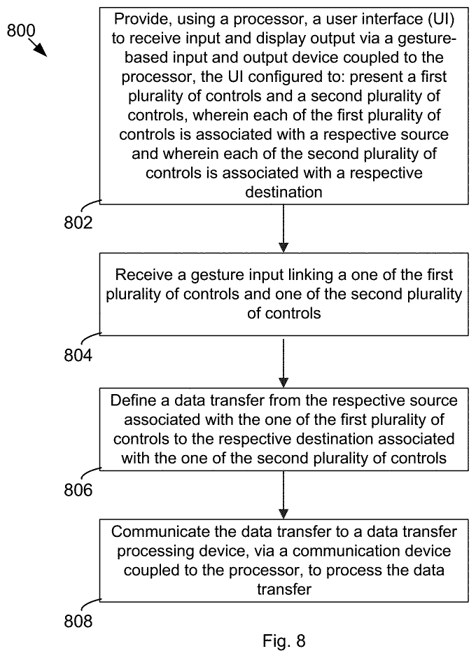

FIG. 8 is a flowchart of operations 800 which may be performed by a computing device such as computing device 102. The computing device may comprise a processor configured to communicate with a display to provide a graphical user interface (GUI) where the computing device has an input device to receive gestural input interacting with the GUI and wherein instructions (stored in a non-transient storage device), which when executed by the processor, configure the computing device to perform operations such as operations 800.

At 802, operations provide a user interface (UI) to receive input and display output via a gesture-based input and output device coupled to the processor. The UI is configured to present a first plurality of controls and a second plurality of controls, wherein each of the first plurality of controls is associated with a respective source and wherein each of the second plurality of controls is associated with a respective destination. The UI is further configured to receive a gesture input linking a one of the first plurality of controls and one of the second plurality of controls. At 804, operations receive a gesture input linking a one of the first plurality of controls and one of the second plurality of controls.

At 806, operations of the computing device define a data transfer from the respective source associated with the one of the first plurality of controls to the respective destination associated with the one of the second plurality of controls. At 806, operations of the computing device 102 communicate the data transfer to a data transfer processing device, via a communication device coupled to the processor, to process the data transfer.

As shown in the various views of the UI, the UI may be configured to receive a gesture input linking one of the first plurality of controls and one or more of the second plurality of controls. In response to a gesture input linking the one of the first plurality of controls to at least two of the second plurality of controls, operations may define respective data transfers comprising one transfer to each respective destination associated with the at least two of the second plurality of controls.

As shown in the various views of the UI, the UI may be configured to receive a gesture input linking one or more of the first plurality of controls and the one of the second plurality of controls. In response to a gesture input linking at least two of the first plurality of controls, operations define respective data transfers as a split transfer from each respective source associated with the at least two of the first plurality of controls to the respective destination associated with the one of the plurality of second controls.

Further, as shown, the UI may be configured to receive a single gestural input to link: i) two of the first plurality of controls with one of the second plurality of controls; or ii) one of the first plurality of controls with two of the second plurality of controls. In such a case, defining a data transfer defines two data transfers in response to respective pairs of linked controls.

As shown in the various views of the UI, the UI may be configured to: receive a first component of the gesture input as a selection of the one of the first plurality of controls or a selection of the one of the second plurality of controls; and receive a second component of the gesture input as a selection of the other of the one of the first plurality of controls or the one of the second plurality of controls.

As shown in the various views of the UI, the UI may be configured to, in response to the gesture input and before defining the data transfer, provide a secondary UI to further configure the data transfer. The second plurality of controls may be associated with transfer parameters defining a request and the secondary UI may be configured to present at least one of: an interface to instruct the computing device to define the data transfer to fully satisfy the request in accordance with the transfer parameters; an interface to instruct the computing device to define the data transfer to minimally satisfy the request in accordance with the transfer parameters; and an interface to instruct the computing device to define the data transfer with custom information. The request may be a payment request, the transfer parameters may comprise a full payment amount and the secondary UI may be configured to receive input to specify an amount to be transferred.

The gesture input maybe a swipe input comprising a selection and movement linking the one of the first plurality of controls and the one of the second plurality of controls.

As shown in the various views of the UI, the UI may be configured to present a confirmation control to receive a confirmation input to communicate the data transfer.

Operations may define a plurality of data transfers and the UI may be further configured to present the plurality of data transfers before communicating and present a batch confirmation control to receive a single confirmation input to confirm each individual data transfer of the plurality of data transfers. Each individual data transfer may be presented with a respective cancel control to receive a cancel input to cancel any individual data transfer.

Operations may communicate via the communication device with an information storage device to: receive respective source information for each of the first plurality of controls, each of the first plurality of controls displayed in association with the respective source information; and receive respective destination information for each of the second plurality of controls, each of the second plurality of controls displayed in association with the respective destination information. Operations may use the respective source information and respective destination information when defining the data transfer.

Each respective source may be a respective financial account, each respective destination may be a respective unpaid bill and the data transfer may be a bill payment.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium. By way of example, and not limitation, such computer-readable storage media can comprise RAM, ROM, EEPROM, optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a wired or wireless technologies, such are included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more general purpose microprocessors, application specific integrated circuits (ASICs), field programmable logic arrays (FPGAs), digital signal processors (DSPs), or other similar integrated or discrete logic circuitry. The term “processor,” as used herein may refer to any of the foregoing examples or any other suitable structure to implement the described techniques. In addition, in some aspects, the functionality described may be provided within dedicated software modules and/or hardware. Also, the techniques could be fully implemented in one or more circuits or logic elements. The techniques of this disclosure may be implemented in a wide variety of devices or apparatuses, an integrated circuit (IC) or a set of ICs (e.g., a chip set).

While this specification contains many specifics, these should not be construed as limitations, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. The scope of the claims should not be limited by the embodiments set forth in the examples, but should be given the broadest interpretation consistent with the description as a whole.

What is claimed is:

1. A computing device comprising a processor, a storage device and a communication device where each of the storage device and the communication device is coupled to the processor, the storage device storing instructions, which when executed by the processor, configure the computing device to:
provide a user interface (UI) to receive input and display output via a gesture-based input and output device coupled to the processor, the UI configured to:
present a first plurality of controls and a second plurality of controls, wherein each of the first plurality of controls is associated with a respective source and wherein each of the second plurality of controls is associated with a respective destination; and
receive a gesture input linking a one of the first plurality of controls and one of the second plurality of controls;
define a data transfer from the respective source associated with the one of the first plurality of controls to the respective destination associated with the one of the second plurality of controls; and
communicate the data transfer to a data transfer processing device, via the communication device, to process the data transfer.

2. The computing device of claim 1 wherein the UI is configured to receive a gesture input linking one of the first plurality of controls and one or more of the second plurality of controls.

3. The computing device of claim 2 wherein, in response to a gesture input linking the one of the first plurality of controls to at least two of the second plurality of controls, the instructions configure the processor to define respective data transfers comprising one transfer to each respective destination associated with the at least two of the second plurality of controls.

4. The computing device of claim 1 wherein the UI is configured to receive a gesture input linking one or more of the first plurality of controls and the one of the second plurality of controls.

5. The computing device of claim 4 wherein, in response to a gesture input linking at least two of the first plurality of controls, the instructions configure the processor to define respective data transfers as a split transfer from each respective source associated with the at least two of the first plurality of controls to the respective destination associated with the one of the plurality of second controls.

6. The computing device of claim 1 wherein the UI is configured to:
receive a first component of the gesture input as a selection of the one of the first plurality of controls or a selection of the one of the second plurality of controls; and
receive a second component of the gesture input as a selection of the other of the one of the first plurality of controls or the one of the second plurality of controls.

7. The computing device of claim 1 wherein the UI is configured to, in response to the gesture input and before defining the data transfer, provide a secondary UI to further configure the data transfer.

8. The computing device of claim 7 wherein the second plurality of controls is further associated with transfer parameters defining a request and wherein the secondary UI is configured to present at least one of:
an interface to instruct the computing device to define the data transfer to fully satisfy the request in accordance with the transfer parameters;
an interface to instruct the computing device to define the data transfer to minimally satisfy the request in accordance with the transfer parameters; and
an interface to instruct the computing device to define the data transfer with custom information.

9. The computing device of claim 8 wherein the request comprises a payment request, the transfer parameters comprise a full payment amount and wherein the secondary UI is configured to receive input to specify an amount to be transferred.

10. The computing device of claim 1 wherein the gesture input comprises a swipe input comprising a selection and movement linking the one of the first plurality of controls and the one of the second plurality of controls.

11. The computing device of claim 1 wherein the UI is configured to present a confirmation control to receive a confirmation input to communicate the data transfer.

12. The computing device of claim 1 wherein the instructions configure the processor to define a plurality of data transfers and the UI is further configured to present the plurality of data transfers before communicating and present a batch confirmation control to receive a single confirmation input to confirm each individual data transfer of the plurality of data transfers.

13. The computing device of claim 12 wherein each individual data transfer is presented with a respective cancel control to receive a cancel input to cancel any individual data transfer.

14. The computing device of claim 1 configured to communicate via the communication device with an information storage device to:
receive respective source information for each of the first plurality of controls, each of the first plurality of controls displayed in association with the respective source information; and
receive respective destination information for each of the second plurality of controls, each of the second plurality of controls displayed in association with the respective destination information.

15. The computing device of claim 14 wherein the instructions configure the processor to use the respective source information and respective destination information when defining the data transfer.

16. The computing device of claim 1 wherein each respective source comprises a respective financial account, each respective destination comprises a respective unpaid bill and wherein the data transfer comprises a bill payment.

17. A computer implemented method comprising:
providing a user interface (UI) to receive input and display output via a gesture-based input and output device coupled to a processor, the UI configured to:
present a first plurality of controls and a second plurality of controls, wherein each of the first plurality of controls is associated with a respective source and wherein each of the second plurality of controls is associated with a respective destination; and
receive a gesture input linking a one of the first plurality of controls and one of the second plurality of controls;
defining a data transfer from the respective source associated with the one of the first plurality of controls to the respective destination associated with the one of the second plurality of controls; and
communicating the data transfer to a data transfer processing device, via a communication device, to process the data transfer.

18. The method of claim 17 wherein each respective source comprises a respective financial account, each respective destination comprises a respective unpaid bill and wherein the data transfer comprises a bill payment.

19. The method of claim 17 wherein the UI is configured to receive a single gestural input to link: i) two of the first plurality of controls with one of the second plurality of controls; or ii) one of the first plurality of controls with two of the second plurality of controls; and wherein defining a data transfer defines two data transfers in response to respective pairs of linked controls.

20. A computer program product comprising a non-transient storage device storing instructions that when executed by at least one processor of a computing device, configure the computing device to:
provide a user interface (UI) to receive input and display output via a gesture-based input and output device coupled to the processor, the UI configured to:
present a first plurality of controls and a second plurality of controls, wherein each of the first plurality of controls is associated with a respective source and wherein each of the second plurality of controls is associated with a respective destination; and
receive a gesture input linking a one of the first plurality of controls and one of the second plurality of controls;
define a data transfer from the respective source associated with the one of the first plurality of controls to the respective destination associated with the one of the second plurality of controls; and
communicate the data transfer to a data transfer processing device, via a communication device coupled to the processor, to process the data transfer.
